(19) United States
(12) Patent Application Publication
(10) Pub. No.: US 2010/0206795 A1
(43) Pub. Date: Aug. 19, 2010

(54) DISTRIBUTOR FOR DOMESTIC WATER FILTERS

(76) Inventor: Larry J. Chernoff, Calgary (CA)

Correspondence Address: MICHAEL J. COLITZ, JR., 640 Douglas Avenue, DUNEDIN, FL, 34698, US

(21) Appl. No.: 12/308,795

(22) PCT Filed: Dec. 5, 2006
(86) PCT No.: PCT/CA2006/001971

§ 371 Date: Dec. 23, 2008

(30) Foreign Application Priority Data
Jun. 23, 2006 (CA) 2,550,911

(51) Int. Cl. B01D 35/30

(52) U.S. Cl. 210/232

(57) ABSTRACT

A generally cylindrical hub with a vertical axis has a bottom and a top and a side wall. The side wall has a plurality of circumferentially spaced radial extending minor cavities. The top has an axial aperture forming a major cavity. A vertically extending hollow cylindrical tube has a lower end received by and supported by the axial aperture. A plurality of generally cylindrical hollow arms extend radially in a common horizontal plane. Each cylindrical arm has a closed exterior end and an interior end received by and supported by an associated radial minor cavity. Each cylindrical arm has a plurality of rows of perforations for the flow of a fluid through the cylindrical tube, the hub, the arms and the rows of perforations.

### RELATED APPLICATIONS

This application is a National Stage filing in the United States of America and claims the benefit of International Application No. PCT/CA2006/001971 filed May 12, 2006 (Dec. 5, 2006) which in turn claims priority benefit of Canadian Application No. 2,550,911 filed Jun. 23, 2006 (Jun. 23, 2006), the subject matter of which applications is incorporated herein by reference.

### BACKGROUND OF THE INVENTION

1. Field of the Invention

The Distributor for Domestic Water Filters is a device for directing, controlling and distributing the flow of water or of a fluid through the media bed of a water filter.

2. Description of the Prior Art

While commercial tanks have large openings in the top of the tank allowing for the introduction of a device for directing, controlling and distributing the flow of water or of a fluid through the media bed of a water filter, the present tanks in use for domestic water filters have a small diameter opening at the top of the tank for the introduction of the distributor, the media and the placement of the control head at the top of the tank. Because the opening in the top of the tank is so small in tanks for the purpose of domestic use, the distributor has to pass through the small opening. In the distributors for domestic use that are currently used, the device for directing, controlling and distributing the flow of water or of a fluid through the media bed of a water fitter is very narrow. Water is directed up the center of the tank through the small device during cleansing or regeneration of the media bed. This leads to a great deal of water being used during this cycle of the filter. Prior to the introduction of the new media in water filters, such as are designed to remove iron, sulfur and such, the media in the beds was light and quite easily lifted by the flow of water or fluid up the central portion of the tank. The newer media that is heavier than the lighter media replaces the lighter media. The lighter media are often used in conjunction with chemicals that may harm the environment whereas the heavier media does not require a chemical.

### SUMMARY OF THE INVENTION

This invention is an improvement over these current distributors. The plurality of arms of the distributor arc constructed of a material that is strong and flexible. The plurality of arms extend outwards from the plurality of cavities of an equal dimension within the central hub so that they nearly touch the inner walls just above the bottom of the tank. The plurality of arms can be folded upwards so that they fit through the small opening on the top of the tank. When inside the tank, no operation is required to unfold the plurality of arms as they return to the position they were in before being folded. The plurality of arms don't collapse when the media is placed on top of them and water or fluids are added to the tank. During the cycle where the water is being filtered, there is no advantage over the other devices in current use. The water or fluid is sent down the tank where it reacts with the media bed so that the impurities in the water coat the media. The water or fluid then travels through the series of small perforations in the plurality of arms, through the hub, through the hollow, cylindrical tube and out to the service line at the top of the tank. The advantage is during the cycle where the water filter is operating to clean or regenerate the media in the tank. The water or fluid then travels down the hollow, cylindrical tube, through the hub of the distributor situated close to the bottom of the tank, into the extended plurality of arms that radiate outwards from the plurality of cavities of an equal dimension within the hub and then travels upwards through the complete area of the media bed and out through the discharge line to drain. The invention allows the complete cleaning of the media within the tank. The benefits are that the filter can remain in service a longer period and the use of less water saves in the use of a valuable resource and this helps in prevention of the overflowing of septic tanks or septic fields when the discharge leads to these. Other benefits are a saving in power. The use of less power leads to less strain on pumps, pressure tanks, and pressure fittings. The media in the bed of the tank receives a more thorough cleaning and thus the filter operates more efficiently. Since the media bed does not fill up with impurities this leads to less frequent changing of the media bed. Because the distributor operates efficiently, it is less likely that impurities will enter the service water that may cause damage to plumbing fixtures and appliances.

### BRIEF DESCRIPTION OF THE DRAWINGS

The invention, as exemplified by a preferred embodiment, is described with reference to the drawings in which:

FIG. 1 is a transparent frontal view of the distributor 100; and

FIG. 2 is a top view of the distributor 100; and

FIG. 3 is a view of the distributor 100 within a water filter 200 depicting the direction and flow of water during service; and

FIG. 4 is a view of the distributor 100 within a water filter 300 depicting the direction and flow of water during backwash or regeneration.

### DETAILED DESCRIPTION OF THE INVENTION

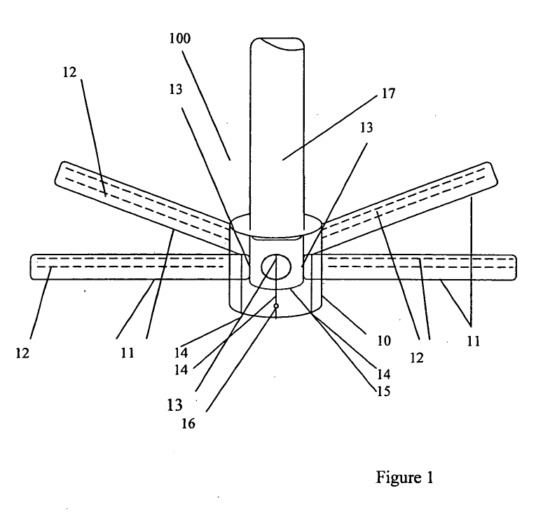

Now referring to the drawings, FIG. 1 shows one embodiment of the invention consisting of a transparent frontal view depicting the device for directing, controlling and distributing the flow of water or of a fluid through the media bed of a water filter 100. In this embodiment the hub 10, is cylindrical and may be made of a durable plastic, metal or other like material. The hub 10 contains a plurality of cavities of equal dimensions 13 bored through the sides of the hub 10, a cavity of a single different dimension than the plurality of cavities of equal dimension 15 bored from the top of the hub 10 so that it terminates just below the plurality of cavities 13 and a small aperture 16 bored through the center of the bottom of the hub 10 so that it terminates within the cavity of a single dimension different from the plurality of cavities of equal dimension 15 of the hub 10. The plurality of arms may be cylindrical in shape and may be made from strong, flexible material mat may be polyethylene, or other similar material. The plurality of arms 11 are fitted into the plurality of cavities of equal dimension 13. The plurality of arms 11 are closed at the end. The plurality of arms 11 have a series of small perforations 12. The hollow, cylindrical tube which may be made from plastic, metal or other like material 17 is shown fitted into the cavity of a single dimension different than the plurality of cavities of equal dimension 15 of the hub 10. A plurality of pegs that may be metal or some other strong material 14 are shown extending from the bottom of the hub 10, traversing through the plurality of arms 11 as a means for fixing the plurality of arms 11 within the plurality of cavities of equal dimension 13 of the hub 10.

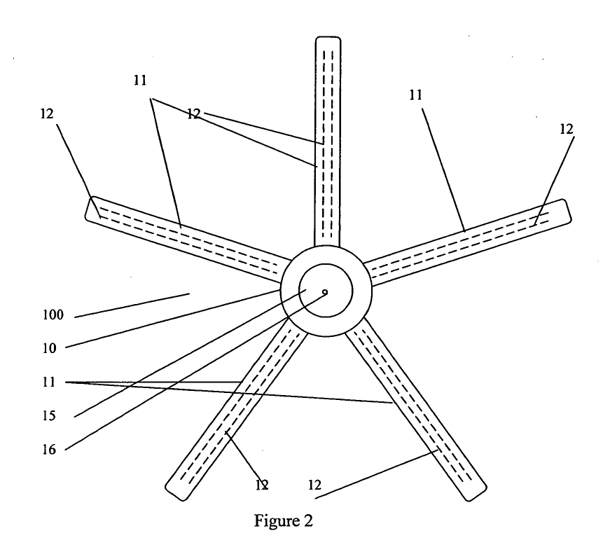

FIG. 2 shows another embodiment of the invention in which the hub 10 is not transparent. Depicted from the top, the drawing shows the placement of the plurality of arms 11 around the diameter of the hub 10 and fitted within the plurality of cavities of equal dimension, not visible, of the hub 10. The small aperture 16 is visible from the top of the hub 10. Also shown is the series of small perforations 12 in the plurality of arms 11.

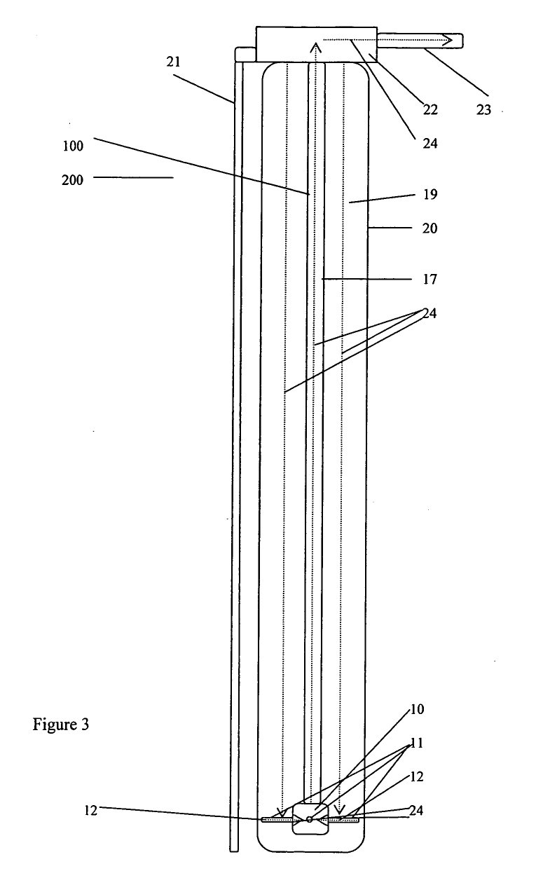

FIG. 3 shows the flow of water through a water filter 200 during service. In the water filter 200, the water flows as depicted by arrows 24, through the control valve 22, downwards through the media bed 19 within the filter tank 20, through the series of small perforations 12 in the plurality of arms 11, through the hub 10, upwards through the hollow, cylindrical tube 17, through the control valve 22 and through the service line 23.

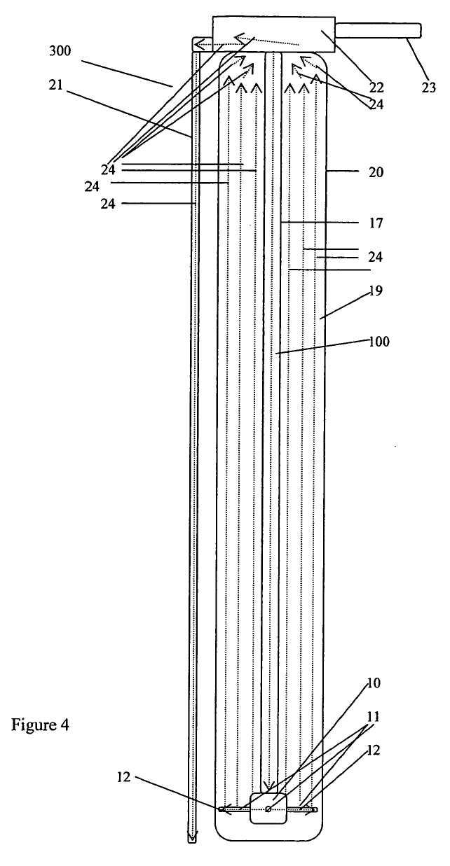

FIG. 4 shows the flow of water or fluid through a water filter 300 during backwash or regeneration. In the water filter 300, the water or fluid flows as depicted by arrows 24, through the control valve 22, down the hollow, cylindrical tube 17, through the hub 10, into the plurality of arms 11, through the series of perforations 12, in the plurality of arms 11, upwards through the complete media bed 19 within the filter tank 20, through the control head 22 and down the drain 100 line 21.

Although only two embodiments of the present invention have been described and illustrated, the present invention is not limited to the features of these embodiments but includes all variations and modifications within the scope of the claims.

What is claimed as being new and desired to be protected by Letters Patent of the United States is as follows:

1. A distributor for domestic water filters comprising:
a generally cylindrical hub with a vertical axis, the hub having a bottom and a top with a side wall between the bottom and the top, the side wall having a plurality of circumferentially spaced radially extending minor cavities, the top having an axial aperture forming a major cavity;
a vertically extending hollow cylindrical tube, the cylindrical tube having a lower end received by and supported by the axial aperture;
a plurality of generally cylindrical hollow arms extending radially in a common horizontal plane, the hollow arms each having a closed exterior end and an interior end received by and supported by an associated radial minor cavity, each of the hollow arms having a plurality of rows of perforations for the flow of a fluid through the cylindrical tube, the hub, the arms and the rows of perforations.

2. The distributor as set forth in claim 1 wherein;
the hub is fabricated of a durable material chosen from the class of durable materials including plastic and metal;
the cylindrical tube is fabricated of a material chosen from the class of materials including plastic and metal; and
the hollow arms are fabricated of a strong flexible material.

3. The distributor as set forth in claim 1 and further including a plurality of pegs, each peg extending through the bottom of the hub and the exterior end of an associated hollow arm for securing the hollow arms in the minor cavities.

4. The distributor a set forth in claim 1 and further including:
a vertically disposed cylindrical tank having a closed lower end and an upper end and with a cylindrical side wall between the lower end and the upper end, the cylindrical tube being of a length to fit within the tank with the bottom of the hub closely spaced from the lower end of the tank, the hollow arms having a diameter to fit within the tank with their exterior ends closely spaced from the wall of the tank.

5. The distributor as set forth in claim 4 and further including:
a media bed in the tank between the distributor and the side wall of the tank.

6. A distributor system for domestic water filters, the system adapted to direct, control and distribute the flow of a fluid through a media bed of a water filter, the device comprising, in combination:
a generally cylindrical hub with a vertical axis, the hub having a bottom and a top with a side wall between the bottom and the top, the side wall having a plurality of circumferentially spaced radially extending minor cavities, the top having an axial aperture forming a major cavity;
a vertically extending hollow cylindrical tube, the cylindrical tube having a lower end received by and supported by the axial aperture;
a plurality of generally cylindrical hollow arms extending radially in a common horizontal plane, the hollow arms each having a closed exterior end and an interior end received by and supported by an associated radial minor cavity, each of the hollow arms having a plurality of rows of perforations for the flow of a fluid through the cylindrical tube, the hub, the arms and the rows of perforations, wherein;
the hub is fabricated of a durable material chosen from the class of durable materials including plastic and metal;
the cylindrical tube is fabricated of a material chosen from the class of materials including plastic and metal; and
the hollow arms are fabricated of polyethylene;
a plurality of peas, each pea extending through the bottom of the hub and the interior end of an associated hollow arm for securing the hollow arms in the minor cavities;
a vertically disposed cylindrical tank having a closed lower end and an upper end and with a cylindrical side wall between the lower end and the upper end, the tank being of a length to receive the distributor with the bottom of the hub closely spaced from the lower end of the tank, the tank having a diameter to receive the hollow arms with their exterior ends closely spaced from the wall of the tank; and
a media bed in the tank between the distributor and the side wall of the tank whereby when the fluid is directed down through the hollow tube into the hub, through the plurality of hollow arms, through the series of perforations in the plurality of arms, then upwards through the media bed a thorough cleansing of the media bed is provided.

7-23. (canceled)
